(19) United States
(12) Patent Application Publication
(10) Pub. No.: US 2015/0207365 A1
(43) Pub. Date: Jul. 23, 2015

(54) SUPERCONDUCTING POWER GENERATION SYSTEM AND ASSOCIATED METHOD FOR GENERATING POWER

(71) Applicant: General Electric Company, Schenectady, NY (US)

(72) Inventors: Kiruba Sivasubramaniam Haran, Clifton Park, NY (US); Ernst Wolfgang Stautner, Niskayuna, NY (US); James Humphrie Rochford, Troy, NY (US); Andrew Allen Rockhill, Mechanicville, NY (US); Ruben Jeevanasan Fair, Niskayuna, NY (US); Renuka Rajput-Ghoshal, Yorktown, VA (US)

(73) Assignee: General Electric Company, Schenectady, NY (US)

(21) Appl. No.: 14/097,361

(22) Filed: Dec. 5, 2013

(51) Int. Cl. H02K 1/06; H02K 9/20

(52) U.S. Cl. CPC H02K 1/06; H02K 9/20

(57) ABSTRACT

A system includes a generator unit coupleable to a hydro turbine. The generator unit includes a casing having a first stationary support coupleable to a base disposed within water and a superconducting generator disposed within the casing. The superconducting generator includes an annular armature and an annular field winding including a plurality of superconducting magnets disposed coaxial with the annular armature and separated by a gap. One of the annular armature and the annular field winding is rotatable by the hydro turbine and other of the annular armature and the annular field winding is stationary.

### BACKGROUND

The invention relates generally to electric power generation systems, and, more particularly, to a superconducting bulb hydro machine used for generating electric power.

A direct drive generator driven by a plurality of blades of a hydro turbine is efficient and has minimal losses due to transmission of torque from the plurality of turbine blades to the generator. However, conventional direct drive generators typically have low torque density and are too heavy for the hydro turbine. Use of indirect drive generators, which usually include a gearbox and a shaft, results in a compact high speed generator. However, such gear boxes tend to be unreliable and not suitable in a hydro application.

There is a need for an enhanced direct drive generator for hydro turbines that is reliable, light weight, and capable of generating electrical power.

### BRIEF DESCRIPTION

In accordance with one exemplary embodiment, a system is disclosed. The system includes a generator unit coupleable to a hydro turbine. The generator unit includes a casing having a first stationary support coupleable to a base disposed within water and a superconducting generator disposed within the casing. The superconducting generator includes an annular armature and an annular field winding including a plurality of superconducting magnets disposed coaxial with the annular armature and separated by a gap. One of the annular armature and the annular field winding is rotatable by the hydro turbine and other of the annular armature and the annular field winding is stationary.

In accordance with another exemplary embodiment, a method for generating electric power is disclosed. The method involves generating a magnetic field in a superconducting generator. The superconducting generator is disposed within a casing having a first stationary support coupleable to a base disposed within water. The method further involves generating electric current by rotating one of an annular armature and an annular field winding of the superconducting generator via a hydro turbine. The method further involves transmitting the generated electric current to a power converter.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a superconducting bulb hydro machine in accordance with an exemplary embodiment of the present invention;

FIG. 2 is a schematic cross-section of a superconducting generator having an annular armature and an annular super-conducting field winding in accordance with an exemplary embodiment of the present invention;

FIG. 3 is a schematic cross-section of the cryostat housing having a plurality of superconducting coils/magnets in accordance with an exemplary embodiment of the present invention;

FIG. 4 is a perspective view of a casing which is a vessel used to hold a plurality of superconducting magnets in contact with liquid cryogen in accordance with an embodiment of FIG. 3;

FIG. 5 is a graph illustrating variation of efficiency with respect to load factor in accordance with an exemplary embodiment of the present invention;

FIG. 6 is a graph illustrating variation of power density with respect to machine rating in accordance with an exemplary embodiment of the present invention;

FIG. 7 is a graph illustrating variation of machine weight with respect to machine rating in accordance with an exemplary embodiment of the present invention; and

FIG. 8 is a graph illustrating variation of torque density with respect to machine rating in accordance with an exemplary embodiment of the present invention.

### DETAILED DESCRIPTION

Embodiments of the present invention disclose a superconducting bulb hydro machine and a method of generating electric power via the superconducting bulb hydro machine. The superconducting bulb hydro machine includes a generator unit coupled to a hydro turbine. The generator unit includes a superconducting generator disposed within a casing. The casing has a first stationary support coupleable to a base disposed within water. The superconducting generator includes an annular field winding having a plurality of superconducting magnets disposed coaxial with an annular armature and separated by a gap. One of the annular armature and the annular field winding is rotatable by the hydro turbine and other of the annular armature and the annular field winding is stationary.

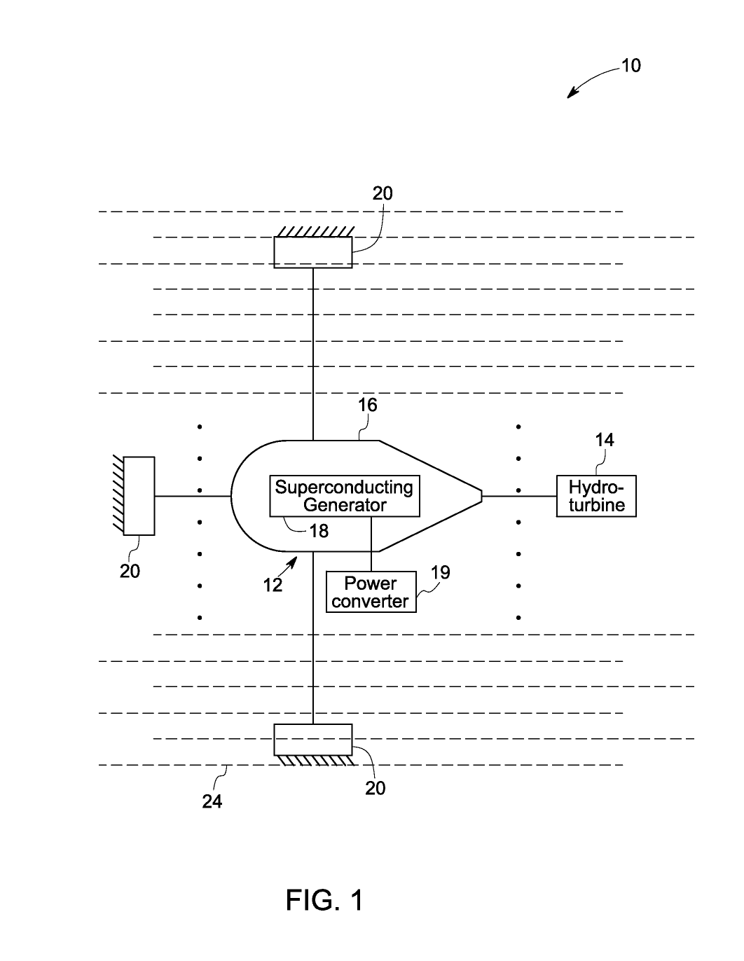

FIG. 1 is a diagrammatical representation of a system 10 i.e. a superconducting bulb hydro machine, in accordance with an exemplary embodiment of the present invention. The system 10 includes a generator unit 12 and a hydro turbine 14 coupled to the generator unit 12. The generator unit 12 includes a casing 16, for example, a bulb type casing and a superconducting generator 18 disposed within the bulb type casing 16. The superconducting generator 18 is explained in greater detail with reference to a subsequent figure. The bulb type casing 16 has a plurality of first stationary supports 20 coupled to a base 22 disposed within water 24. The stationary supports 20 includes vertical supports and horizontal supports capable of supporting water thrust loads and torque loads from the superconducting generator 18. Electric power generated by the superconducting generator 18 is transmitted to a power converter 19.

Typical hydro power systems includes two cost components i.e. cost associated with civil construction of the hydropower system and cost related to electro-mechanical equipment in the hydropower system. The electro-mechanical equipment includes turbines, generators, transformers, cabling and associated control systems. In relatively smaller hydropower systems, the electromechanical equipment constitutes a larger proportion of the overall size and cost. The exemplary system 10 overcomes the drawbacks associated with the conventional hydro power systems.

The exemplary system 10 used to generate electrical power, is employed in run-of-the-river hydro and tidal schemes, where water heads are considered to be relatively lower, for example in a range of 10 to 12 meters. Flowing water 24 turns the hydro turbine 14 which then drives the superconducting generator 18 to produce electric power. Conventional direct drive machines are usually very large in diameter (for example, up to 8 meters) and very heavy (for example, 160 tons). Substantial foundations are required to support such large conventional machines. The typical electrical efficiencies of such conventional machines are also relatively low. Replacing the conventional generator with the exemplary generator unit 12 results in a light weight system having a relatively higher efficiency.

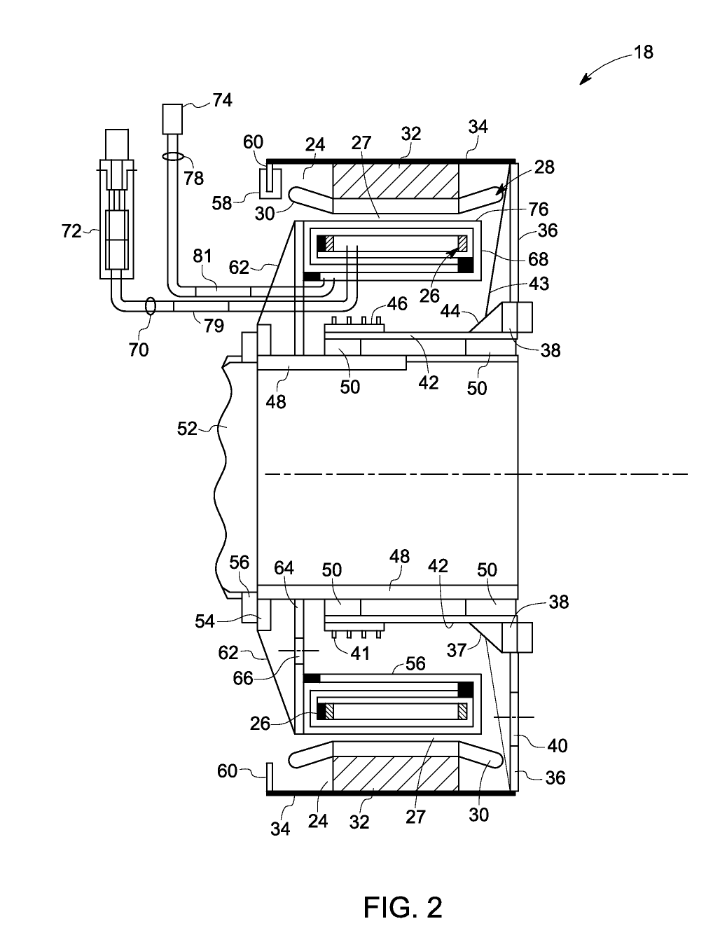

FIG. 2 illustrates a cross-section of the superconducting generator 18 having an annular armature 24 and an annular super-conducting field winding 26. The annular super-conducting field winding 26 is separated by a gap 27 and surrounded by the annular armature 24. Specifically, the armature 24 is an outer annular ring disposed co-axially around the field winding 26. In the illustrated embodiment, the annular armature 24 is rotatable and the field winding 26 is stationary. The armature 24 includes a plurality of conductive windings 28 (coils or bars) arranged along a longitudinal direction. The conductive windings 28 are coupled to each other, at opposite ends, via conductive end turns 30.

The armature 24 further includes a cylindrical yoke 32 that support the conductive windings 28. An outer surface of the cylindrical yoke 32 is fixed to a cylindrical housing 34. The cylindrical housing 34 rotates along with the armature 24. The cylindrical housing 34 is fitted to a circular disc 36 having a central circular aperture mounted to an annular bracket 38. The annular bracket 38 is coupled to a hub of the hydro turbine. The circular disc 36 additionally includes openings 40 for reducing weight.

The annular bracket 38 is mounted on an end of a rotatable cylindrical support tube 42 disposed radially inward from the conductive windings 28. Reinforcement gussets 43 are disposed between the circular disk 36 and the support tube 42. A reinforcing ring 44 is coupled to an inner corner between the bracket 38 and the support tube 42. A slip ring assembly 46 is provided on an outer surface of the support tube 42 and rotatable with the support tube 42. The slip ring assembly 46 is further electrically coupled to the conductive windings 28.

The support tube 42 is rotatably supported on a stationary base tube 48 via a pair of annular bearings 50. The stationary base tube 48 is attached to a mount 52. The mount 52 is attached to a bracket 54 via a ring bracket 56. The brackets 54, 56 may be secured together via bolts.

A disc brake 58 is coupled to an annular lip 60 provided at an end of the housing 34. The base tube 48 supports a support disc 64 (also referred to as a second stationary support) used for mounting the super-conducting field winding 26. The support disc 64 includes one or more holes 66 for reducing weight. A plurality of reinforcement gussets 62 extend from the base tube 48 to the support disc 64. The support disc 64 is coupled to one end of a cryostat housing 68 containing a plurality of superconducting coils of the super-conducting field winding 26. The housing 68 and a plurality of cooling components form a cryostat.

The housing 68 includes a plurality of insulated conduits 70 for receiving a cryogenic liquid, for example liquid helium, from a two-stage re-condenser 72. The cryogenic liquid is fed around a plurality of superconducting magnets of the super-conducting field winding 26 so as to cool the superconducting magnets to achieve a superconducting condition. Cryogen vapor generated after cooling is fed through the conduits 70 to the re-condenser 72, where the cryogen vapor is again cooled, liquefied and then returned via the conduits 70 to the superconducting magnets.

In the illustrated embodiment, another re-condenser 74 may be optionally provided provides a cooling liquid, for example liquid nitrogen, neon or nitrogen, to an inner thermal shield 76 of the housing 68. The cooling liquid is used to cool the thermal shield 76 to a temperature in a range of 30 Kelvin to 80 Kelvin. Cooling the thermal shield assists in cooling the super-conducting field winding 26 by reducing the thermal radiation adsorbed by the helium. The re-condenser 74 receives the vaporized liquid from the thermal shield 76, liquefies the vapor, and then again feeds the cooling liquid to the thermal shield 76 via a plurality of insulated conduits 78. The re-condenser 74 is mounted at a location higher than the housing 68. In another embodiment, instead of the re-condenser 74, the re-condenser 72 has a first cooling stage for cooling the thermal shield 76. In one example, warm helium vapor fed from the superconducting coils to the re-condenser 72, may be redirected to cool the thermal shield 76.

Torque is applied by the hydro turbine to rotate the armature 24 around the super-conducting field winding 26. Torque is applied from the armature 24 to the super-conducting field winding 26 due to electromagnetic force coupling. The torque applied to the super-conducting field winding 26, is transmitted by the housing 68 to the support disc 64 and the mount 52.

In another embodiment, the annular armature 24 is stationary and the field winding 26 is rotatable. In such an embodiment, a rotatable helium coupling 79 may be optionally provided in the conduit 70. Further, in such an embodiment, a rotatable helium coupling 81 may be optionally provided in the insulated conduit 78.

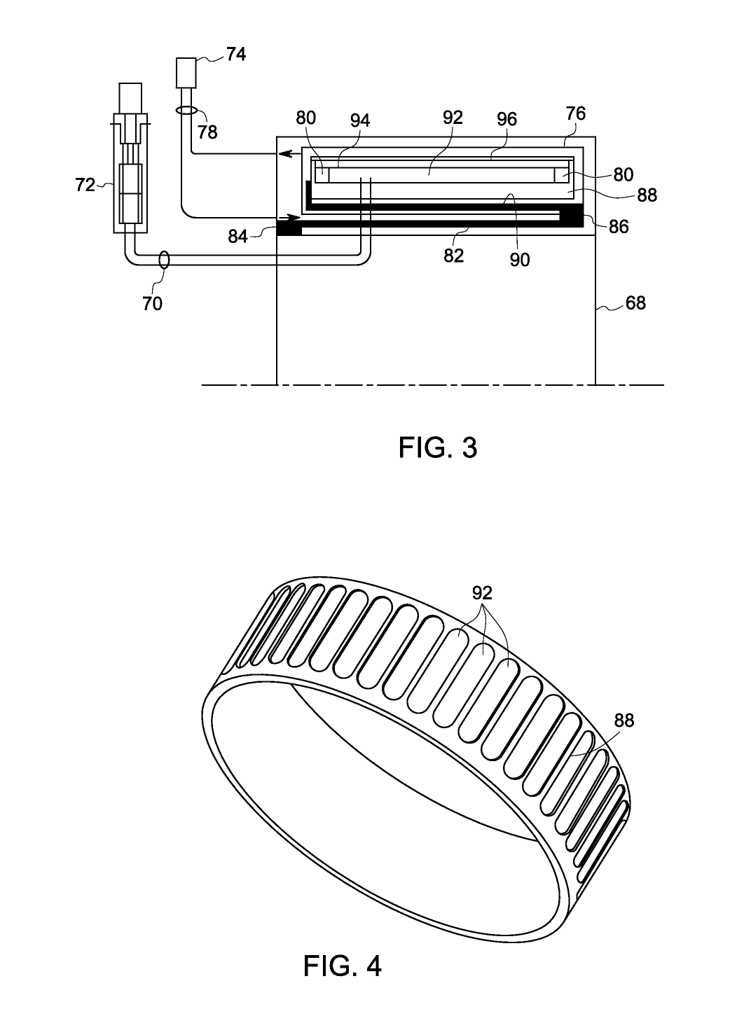

FIG. 3 is a schematic cross-section of the cryostat housing 68 having a plurality of superconducting coils/magnets 80. An insulating vacuum is formed around the thermal shield 76 and the superconducting coils 80. The thermal shield 76 is suspended in the housing 68 via a torque tube 82. The torque tube 82 is mounted on an annular flange 84 within the housing 68. Another flange 86 is provided at another end of the torque tube 82 facilitates to elevate the thermal shield 76 from the torque tube 82. An annular casing 88 is suspended within the thermal shield 76.

One end of a torque tube 90 is supported by the flange 86 against an inner wall of the thermal shield 76. The torque tube 90 is used to thermally insulate and suspend the annular casing 88 from the thermal shield 76. Further, the torque tube 90 transmits torque from the superconducting coils/magnets 80 to the torque tube 82.

FIG. 4 is a perspective view of the casing 88 which is a vessel used to hold the superconducting magnets 80 in contact with liquid cryogen in accordance with an embodiment of FIG. 3. The casing 88 includes an annular array of hollow recesses 92, each recess 92 configured to receive a race track shaped superconducting magnet 80. A cover 94 is disposed above the magnet 80 within the recess 92. The cover 94 is used to secure the magnet 80 within the recess 92. Further, the cover 94 allows the cooling liquid to flow over and through the superconducting magnets 80. A cylindrical shell 96 is used to seal the hollow center of the casing 88. Each superconducting magnet 80 may include a group of wires shaped to form a race track. The group of wires may be any superconducting wires such as low temperature superconducting wires, high temperature superconducting wires, or the like. In some other embodiments, the cooling conduits may be embedded within the casing 88 such that the superconducting magnets 80 are not in direct contact with the cooling liquid and are cooled by conduction.

In accordance with the embodiments discussed herein, use of the exemplary superconducting generator results in a smaller, lighter superconducting bulb hydro machine for a hydro or tidal scheme. Use of the exemplary superconducting generator also improves the efficiency of the superconducting bulb hydro machine.

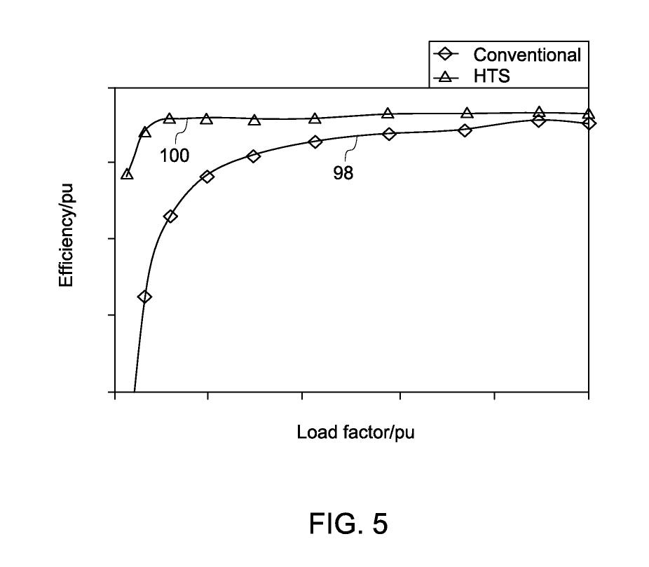

FIG. 5 is a graph illustrating variation of efficiency (represented by y-axis) with respect to load factor (represented by x-axis). A curve 98 is representative of variation of efficiency of a conventional generator with respect to load factor. A curve 100 is representative of variation of efficiency of a high temperature superconducting generator employed for a hydro application in accordance with an exemplary embodiment of the present invention.

The efficiency is enhanced in the superconducting generator because there is reduced electric dissipation. The efficiency is further enhanced in the superconducting generator under partial load conditions, due to features such as air gap winding, higher magnetic flux, higher density super-conducting field windings. The exemplary superconducting generator has reduced size and weight, which facilitates retrofitting to an existing hydropower station facility.

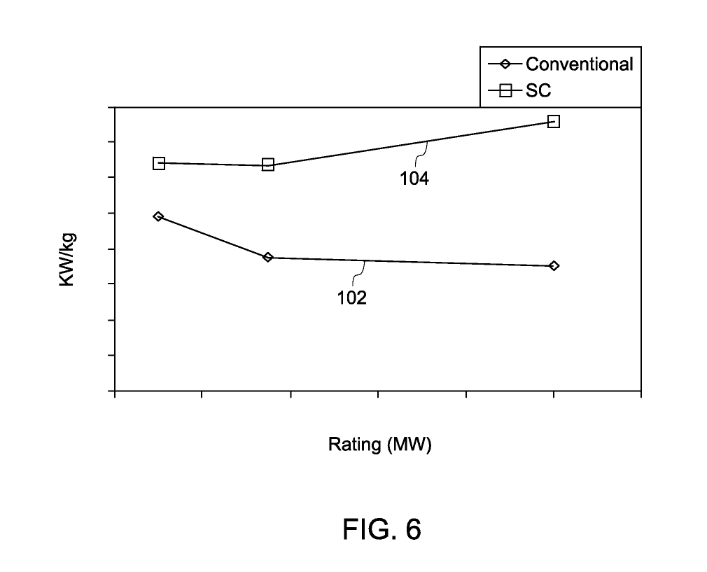

FIG. 6 is a graph illustrating variation of power density (represented by y-axis) with respect to machine rating (represented by x-axis). A curve 102 is representative of variation of power density of a conventional generator with respect to machine rating. A curve 104 is representative of variation of power density of a high temperature superconducting generator with respect to machine rating employed for a hydro application in accordance with an exemplary embodiment of the present invention. Use of the exemplary superconducting generator for hydro applications, facilitates to reduce overall size and weight which in turn lead to savings in civil engineering costs.

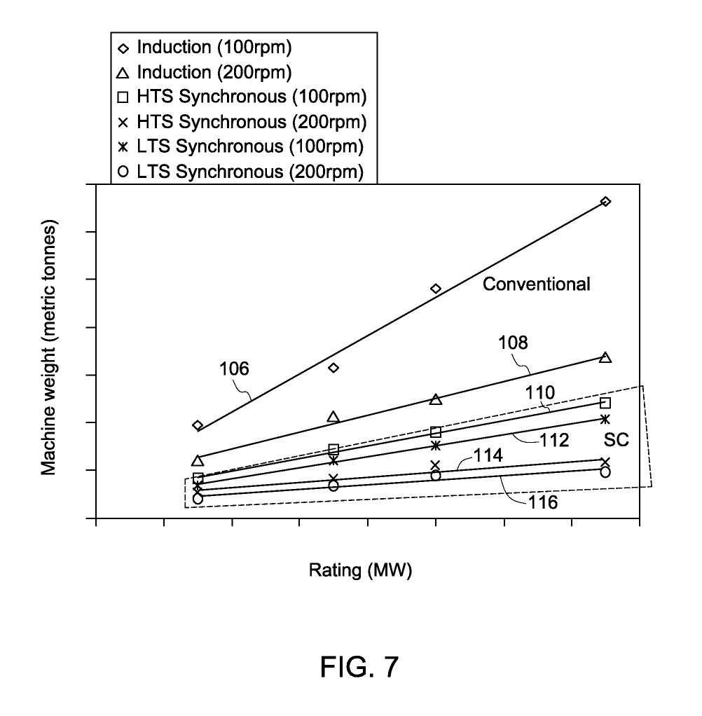

FIG. 7 is a graph illustrating variation of machine weight (represented by y-axis) with respect to machine rating (represented by x-axis). A curve 106 is representative of variation of machine weight of a conventional generator operated at a speed of 100 rpm, for example, with respect to machine rating. A curve 108 is representative of variation of machine weight of a conventional generator operated at a speed of 200 rpm, for example, with respect to machine rating. A curve 110 is representative of variation of machine weight of an exemplary synchronous high temperature superconducting generator operated at a speed of 100 rpm, for example, with respect to machine rating employed for a hydro application in accordance with an exemplary embodiment of the present invention. A curve 112 is representative of variation of machine weight of an exemplary synchronous high temperature superconducting generator operated at a speed of 200 rpm, for example, with respect to machine rating employed for a hydro application in accordance with an exemplary embodiment of the present invention.

A curve 114 is representative of variation of machine weight of an exemplary synchronous low temperature superconducting generator operated at a speed of 100 rpm, for example, with respect to machine rating employed for a hydro application in accordance with an exemplary embodiment of the present invention. A curve 116 is representative of variation of machine weight of an exemplary synchronous low temperature superconducting generator operated at a speed of 200 rpm, for example, with respect to machine rating employed for a hydro application in accordance with an exemplary embodiment of the present invention.

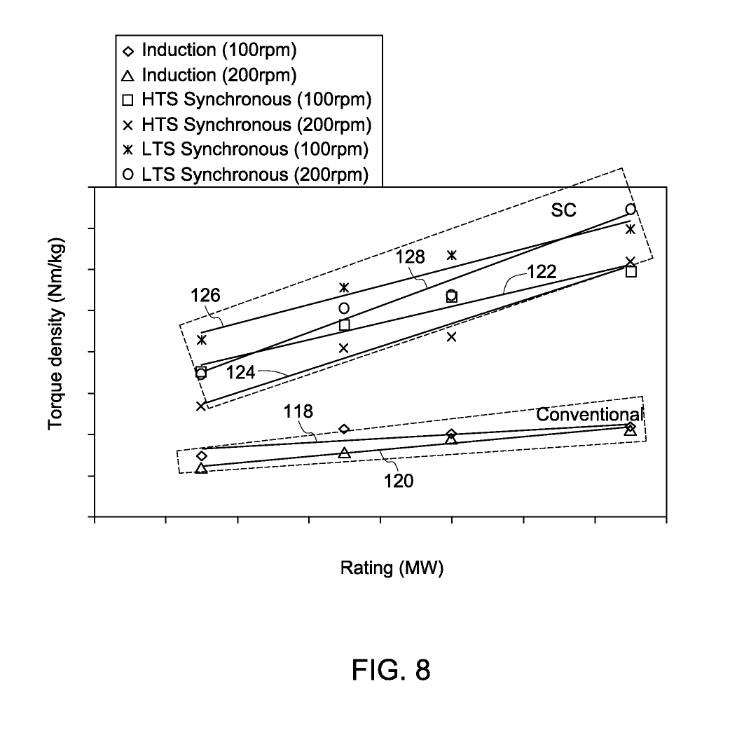

FIG. 8 is a graph illustrating variation of torque density (represented by y-axis) with respect to machine rating (represented by x-axis). A curve 118 is representative of variation of torque density of a conventional generator operated at a speed of 100 rpm, for example, with respect to machine rating. A curve 120 is representative of variation of machine weight of a conventional generator operated at a speed of 200 rpm, for example, with respect to machine rating. A curve 122 is representative of variation of torque density of an exemplary synchronous high temperature superconducting generator operated at a speed of 100 rpm, for example, with respect to machine rating employed for a hydro application in accordance with an exemplary embodiment of the present invention. A curve 124 is representative of variation of torque density of an exemplary synchronous high temperature superconducting generator operated at a speed of 200 rpm, for example, with respect to machine rating employed for a hydro application in accordance with an exemplary embodiment of the present invention.

A curve 126 is representative of variation of torque density of an exemplary synchronous low temperature superconducting generator operated at a speed of 100 rpm, for example, with respect to machine rating employed for a hydro application in accordance with an exemplary embodiment of the present invention. A curve 116 is representative of variation of torque density of an exemplary synchronous low temperature superconducting generator operated at a speed of 200 rpm, for example, with respect to machine rating employed for a hydro application in accordance with an exemplary embodiment of the present invention.

In accordance with the embodiments of the present invention, an exemplary superconducting generator has higher torque density and relatively light weight. The superconducting generator is directly driven by blades of the hydro turbine. The exemplary superconducting bulb hydro machine may also be applicable for marine propulsion systems applied to marine ships, oceanographic vessels, cable layers, or the like due to advantages associated with fuel savings, reduced size, reduced noise, and cost.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a generator unit coupleable to a hydro turbine, the generator unit comprising:
a casing having a first stationary support coupleable to a base disposed within water; and
a superconducting generator disposed within the casing; the superconducting generator comprising:
an annular armature; and
an annular field winding including a plurality of superconducting magnets disposed coaxial with the annular armature and separated by a gap; wherein one of the annular armature and the annular field winding is rotatable by the hydro turbine and other of the annular armature and the annular field winding is stationary.

2. The system of claim 1, wherein the casing is a bulb type casing.

3. The system of claim 1, wherein the annular armature is rotatable and the annular field winding is stationary.

4. The system of claim 3, further comprising a second stationary support coupled to the annular field winding.

5. The system of claim 4, wherein the annular field winding comprises an insulating casing coupled to the second stationary support.

6. The system of claim 5, wherein the annular field winding further comprises a thermal shield disposed inside the insulating casing, and a first torque tube for coupling the thermal shield to the insulating casing.

7. The system of claim 6, wherein the annular field winding further comprises an annular casing enclosing a plurality of superconducting magnets, disposed within the thermal shield, and a second torque tube for coupling the annular casing to the thermal shield.

8. The system of claim 5, further comprising a plurality of insulated conduits extending through the insulating housing to a re-condenser.

9. The system of claim 3, further comprising a disc configured to rotate with the annular armature and a brake releasably grasping the disc.

10. The system of claim 3, further comprising a re-condenser mounted above the annular field winding.

11. The system of claim 1, wherein the plurality of superconducting magnets comprises an annular array of racetrack shaped superconducting magnets.

12. The system of claim 1, wherein the annular armature is stationary and the annular field winding is rotatable.

13. A method for generating electric power, the method comprising:
generating a magnetic field in a superconducting generator; wherein the superconducting generator is disposed within a casing having a first stationary support coupleable to a base disposed within water;
generating electric current by rotating one of an annular armature and an annular field winding of the superconducting generator via a hydro turbine; and
transmitting the generated electric current to a power converter.

14. The method of claim 13, further comprising cooling a plurality of superconducting magnets of the annular field winding, using a coolant that is at least partially vaporized during cooling of the plurality of superconducting magnets.

15. The method of claim 14, further comprising condensing the least partially vaporized coolant via a re-condenser mounted above the annular field winding.

16. The method of claim 13, further comprising rotating the armature and holding the annular field winding stationary.

17. The method of claim 13, further comprising rotating the annular field winding and holding the armature stationary.
